(19) United States
(12) Patent Application Publication
(10) Pub. No.: US 2008/0302426 A1
(43) Pub. Date: Dec. 11, 2008

(54) System and method of securing removable components for distribution of fluids

(76) Inventors: Greg Patrick Mulligan, Milpitas, CA (US); Philip Ryan Barros, San Jose, CA (US); Joshua David Anderson, San Jose, CA (US)

Correspondence Address: MICHAEL O. SCHEINBERG, P.O. BOX 164140, AUSTIN, TX, 78716-4140, US

(21) Appl. No.: 11/810,496

(22) Filed: Jun. 6, 2007

(51) Int. Cl. F16J 15/06; F16K 25/00

(52) U.S. Cl. 137/271; 29/428

(57) ABSTRACT

A system for enabling a distribution of fluids includes a backplane and at least two component bases. Each component base has a first flange segment on one side and a second flange segment on an opposite side. Each of the first flange segment and the second flange segment has through holes formed therein. Fasteners secure the two component bases to the backplane. The fasteners extending through the through holes formed in the first flange segment of a first component base and through holes formed in the second flange segment of a second component base and into the backplane. Methods of assembling a distribution system are further provided.

### BACKGROUND OF THE INVENTION

1. Field of Invention

The present invention is directed to a system for enabling a distribution of fluids, and more particularly to a modular manifold system that is adaptable to semi-conductor processing equipment to enable the distribution of fluids in a semi-conductor manufacturing environment by assembling a plurality of individual component bases into a gas stick, for example.

2. Discussion of Related Art

Wafer fabrication facilities are commonly organized to include areas in which chemical vapor deposition, plasma deposition, plasma etching, sputtering and the like are carried out. In order to perform these processes, tools and machines may be used for delivering precise amounts of processing gasses to enable the fabrication steps. These gases may be inert, reactive, or may provide reactive species as desired by the particular manufacturing process.

For example, in order to perform epitaxial deposition, a carrier gas, such as dry nitrogen, may bubble through silicon tetrachloride, which then carries silicon tetrachloride vapor into an epitaxial deposition chamber. In order to deposit a silicon oxide dielectric coating, also known as a deposited oxide coating, silane (SiH₄) is flowed into the tool and oxygen is flowed into the tool where they react to form silicon oxide (SiO₂) on the surface of the wafer. Plasma etching is carried out by supplying carbon tetrachloride and sulfur hexafluoride to a plasma etcher tool. The compounds are ionized, to form reactive halogen species, which then etch the silicon wafer. Silicon nitride may be deposited by the reaction of dichlorosilane and ammonia in a tool. It may be appreciated that in each instance pure carrier gases or reactant gases must be supplied to the tool in contaminant-free, precisely metered quantities.

In a typical wafer fabrication facility, the inert and reactive gases are stored in tanks which may be located in the basement of the facility and which are connected via piping or conduit to a valve manifold box. The tanks and the valve manifold box are considered part of the facility level system. At the tool level, an overall tool system, such as a plasma etcher or the like, includes a gas panel and the tool itself. The gas panel contained in the tool includes a plurality of gas paths having connected therein active components, such as manual valves, pneumatic valves, pressure regulators, pressure transducers, mass flow controllers, filters, purifiers and the like. All have the purpose of delivering precisely metered amounts of pure inert or reactant gas from the valve manifold box to the tool itself.

In certain embodiments, the gas panel is located in a cabinet with the tool and typically occupies a relatively large amount of space, as each of the active devices are plumbed into the gas panel, either through welding tubing to the devices or combination of welds and connectors, such as VCR connectors available from Cajon Corporation.

Gas panels are relatively difficult to manufacture and hence expensive. In a combination VCR connector and welded tubing system, the individual components are held on shimmed supports to provide alignment prior to connections at the VCR fittings. Misalignment at a VCR fitting can result in leakage. In addition, it has been found that VCR fittings often tend to come loose in transit and some gas panel manufacturers assume that the VCR fittings have loosened during transit, possibly admitting contaminants into the system.

Welds are relatively expensive to make in such systems, but are typically carried out using a tungsten inert gas (TIG) system, having an orbital welding head to weld tube stubs together. The welding must take place in an inert atmosphere, such as argon, and even then leads to deterioration of the surface finish within the tubes. One of the important characteristics of modern-day gas panel systems and gas handling systems is that the surfaces of the gas handling equipment that tend to have the gas or vapor contact them must be made as smooth and non-reactive as possible in order to reduce the number of nucleation sites and collection sites where contaminants may tend to deposit in the tube. This phenomenon may lead to the formation of particulates or dust which could contaminate the wafers being processed.

Additional problems with conventional gas panels relate to the fact that a combination of VCR and welded system of the type currently used today typically requires a significant amount of space between each of the components so that during servicing the VCR connections can be accessed and opened. In addition, in order to remove an active component from a contemporary gas panel, many of the supports of the surrounding components must be loosened so that the components can be spread out to allow removal of the active component under consideration.

Such systems should be configured to be easily disassembled so that components of the system may be repaired or replaced. For example, most wafer fabricators are aware that it is only a matter of time until, for instance, the silane lines in the gas panels are “dusted.” “Dusting” occurs when air leaks into an active silane line causing a pyrophoric reaction to take place yielding loose particulate silicon dioxide in the tube, thereby contaminating the line. Other lines also can be contaminated. For example, those which carry chlorine gas used in etchers or which carry hydrogen chloride used in other reactions. Hydrogen chloride mixing with moisture present in the humidity of air produces hydrochloric acid that etches the interior of the tube, roughening it and increasing the number of nucleation sites and the likelihood that unwanted deposits would occur inside the tube. In both of these cases, as well as in others, it would be necessary then to open the particular line in the gas panel in order to clean or replace it. In addition, individual component failures may require a line being opened in order to clean it, which is time consuming and expensive.

Examples of fluid distribution systems can be found in not only the semi-conductor field but in other fields, such as biochemical-related industries. U.S. Pat. No. 5,653,259 discloses the use of a particular form of component base and valving system with a saw tooth design of a common fluid passageway. U.S. Pat. No. 3,384,115 discloses the mounting of pneumatic logic systems on a common component base. U.S. Pat. No. 4,181,141 discloses a pneumatic control circuit that permits a sequential connection of modules by the use of the cylindrical connector plugs.

U.S. Pat. No. 4,352,532 discloses a manifold system that can detachably carry a plurality of pneumatically and electrically operated control units. Likewise, U.S. Pat. No. 4,093,329 discloses a manifold assembly with a plurality of property control units. PCT Publication No. WO98/25058 discloses a gas panel with a plurality of interconnected discrete blocks. Similarly, U.S. Pat. No. 6,394,138 discloses a manifold system having interconnecting blocks. U.S. Pat. Nos. 3,025,878, 4,921,072, 5,662,143 and 5,178,191 and PCT Publication No. WO95/10001 are cited as being of a general interest.

With the advent of fluid control products having multiple functions integrated into a single device, for example measurement of gas pressure and compensating control of mass flow, such as the device described in U.S. Pat. No. 7,073,392, the many fluid processing components envisioned in historically typical gas stick designs, like those described in U.S. Pat. Nos. 5,992,463 and 6,293,310, become superfluous. The standard valve arrangements for controlling process gas inlet, purge gas, possible downstream purge or evacuation, and gas stick outlet, nonetheless remain an industry requirement. Valve designs such as shown in U.S. Patent Application Publication No. 2005/0000570 A1, combine the manual shut-off and remote control functions thereby giving rise to gas sticks containing merely three or four valves and the single flow control device which encompasses multiple functions. Such a gas stick architecture essentially amounts to just one complex flow control device and a few associated valves. In such an arrangement, there is little need for the gas path flexibility offered by surface mount substrate systems, such as described in U.S. Pat. Nos. 5,992,463 and 6,394,138. Not only do such substrate systems offer design flexibility, which will go unused, but the fabrication of the parts in such older style architectures involves substantially more machining than is necessary.

For example, the shut-off opening device of U.S. Pat. No. 5,983,933 teaches use of a “tube fitting” transverse manifold below a valve body, which uses a special coupling block to effect such connection. The shut-off opening device shown in U.S. Pat. No. 5,988,217 teaches use of a two-port valve and a three-port valve immediately preceding a mass flow controller. The adjacent valve bodies are sealingly joined at butting end faces that are generally perpendicular to the long (axial) dimension of the resultant gas stick. As a result, the valve main bodies and channel blocks must be sealingly assembled by axial compression before the fluid control apparatus are mounted to a supporting structure since an annular gasket is interposed between the butting end faces of adjacent blocks and a retainer holds the outer periphery of the gasket to cause the valve main body to retain the gasket. In such an apparatus, the compressed gasket exhibits material deformation that consequently interlocks adjacent parts and prevents movement transverse to the axial direction so a part cannot be secured to a supporting structure independently of those adjacent to it. Conversely, a part securely fastened to a supporting structure could not be subsequently moved in the axial direction to sealingly connect with an adjacent part.

### SUMMARY OF INVENTION

A first aspect of the invention is directed to a system for enabling a distribution of fluids comprising a backplane, at least two component bases, each component base having a first flange segment on one side and a second flange segment on an opposite side, wherein each of the first flange segment and the second flange segment have through holes formed therein, and at least one fastener to secure the at least two component bases to the backplane, the at least one fastener extending through the through holes formed in the first flange segment of a first component base and through holes formed in the second flange segment of a second component base and into the backplane.

Embodiments of the system may further include providing each of the first flange segment and the second flange segment with complimentary configurations that permit the at least two component bases to be interlocked. A first flange segment from one component base overlays a second flange segment of another component base. Each component base has a first fluid passageway and a second fluid passageway. The first fluid passageway includes a first port formed in the second flange segment of the component base and a second port formed in the first flange segment of the component base. The second fluid passageway includes a first port formed on an upper surface of the first flange segment and a second port formed on a lower surface of the first flange segment. The first port of the first fluid passageway is co-planar with the second port of the second fluid passageway. The system further comprises a manifold in fluid communication with at least one of the first fluid passageway and the second fluid passageway of one of the at least two component bases and a seal disposed between one of the at least two component bases and the manifold. The seal is a compressible seal that is compressed when securing the component bases to the backplane with the at least one fastener. The at least two component bases extend in a first direction, and wherein the manifold extends in a second direction, which is generally perpendicular to the first direction. The system further comprises a component mounted on one of the at least two component bases, the component being in fluid communication with at least one of the first fluid passageway and the second fluid passageway.

Another aspect of the invention is directed to a system for enabling a distribution of fluids comprising a backplane, at least two component bases secured to the backplane, each component base being configured to be secured in interlocking relationship with an adjacent component base and having a fluid passageway with a first port and a second port, a manifold in fluid communication with at least one of the first port and the second port of the fluid passageway of one of the at least two component bases, and a seal disposed between the manifold and the at least one of the first port and the second port of the fluid passageway of the at least one of the component bases. The seal is compressed when securing the at least two component bases to the backplane.

Embodiments of the system may further include providing each component base further with a first flange segment on one side and a second flange segment on an opposite side. Each of the first flange segment and the second flange segment have through holes formed therein. Each of the first flange segment and the second flange segment have complimentary configurations that permit the at least two component bases to be interlocked, and wherein a first flange segment from one component base overlays a second flange segment of another component base. The seal is a compressible seal that is compressed when securing the at least two component bases to the backplane.

Yet another aspect of the invention is directed to a manifold system for enabling a distribution of fluids comprising a backplane, at least two component bases, each component base having a fluid passageway with a port, a manifold in fluid communication with the port of one of the at least two component bases, a seal disposed between the port of one of the at least two component bases and the manifold, and at least one fastener to secure the one of the at least two component bases to the backplane, wherein the seal is compressed when securing the one of the at least two component bases to the backplane with the at least one fastener.

Embodiments of the system include providing each component base with a first flange segment on one side and a second flange segment on an opposite side, and wherein each of the first flange segment and the second flange segment have through holes formed therein. Each of the first flange segment and the second flange segment have complimentary configurations that permit the at least two component bases to be interlocked, and wherein a first flange segment from one component base overlays a second flange segment of another component base. The plurality of individual component bases extends in a first direction, and wherein the manifold extends in a second direction, which is generally perpendicular to the first direction.

Another aspect of the invention is directed to a method of assembling a fluid distribution system. The method comprises providing a backplane; providing two component bases, each component base having a first flange segment on one side and a second flange segment on an opposite side, wherein each of the first flange segment and the second flange segment have through holes formed therein; positioning a first component base on the backplane; positioning a second component base on the backplane in a position in which the first flange segment of the second component base overlies the second flange segment of the first component base; and securing the first and second component bases to the backplane. In one embodiment, the method further includes compressing a seal disposed between a manifold disposed under the first flange segment of the first component base.

A further aspect of the invention is directed to a method of assembling a fluid distribution system. The method comprises: providing a backplane; securing at least two component bases to the backplane, each component base having at least one fluid passageway formed therein; positioning a manifold in fluid communication with at least one fluid passageway of one of the at least two component bases; positioning a seal between the manifold and the at least one fluid passageway of one of the at least two component bases; and compressing the seal when securing the one of the at least two component bases to the backplane.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a top perspective view of an exemplary fluid distribution module having component bases of embodiments of the invention;

FIG. 2 is a bottom perspective view of the module shown in FIG. 1;

FIG. 3 is a perspective view of a component base of an embodiment of the invention having two valve ports;

FIG. 4 is a perspective view of a component base of another embodiment of the invention having three valve ports;

FIG. 5 is a perspective view of two exemplary component bases having components mounted thereon prior to their attachment to a backplane (not shown);

FIG. 6 is a perspective cross-sectional view of component bases interconnected with one another of another embodiment of the invention;

FIG. 7 is a perspective partial cross-sectional view of the component bases shown in FIG. 5 attached to the backplane;

FIG. 8 is a perspective partial cross-sectional view of a component prior to its attachment to a component base;

FIGS. 9A-9D are top perspective views of a sequence of assembly of a fluid distribution module of an embodiment of the invention;

FIG. 10 is a top perspective view of a fluid distribution module of an embodiment of the invention;

FIG. 11 is a top perspective view of a fluid distribution module of another embodiment of the invention;

FIG. 12 is a top perspective view of a fluid distribution module of another embodiment of the invention;

FIG. 13 is a top perspective view of a fluid distribution module of another embodiment of the invention; and

FIG. 14 is a top perspective view of a fluid distribution module of another embodiment of the invention.

### DETAILED DESCRIPTION OF THE INVENTION

This invention is not limited in its application to the details of construction and the arrangement of components set forth in the following description or illustrated in the drawings. The invention is capable of other embodiments and of being practiced or of being carried out in various ways. For example, various modifications, may be readily apparent to those skilled in the art, since the general principles of the invention have been defined herein specifically to provide an improved manifold system for enabling a distribution of fluids, such as gases in the semi-conductor field by utilizing modular component bases that can be subjectively configured and interconnected to permit active components to be appropriately sealed for interconnection with the gas passageways. In addition, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Generally, a semi-conductor process tool is a self-contained unit that may handle all the operations involved in fabricating IC patterns and wafers. One of the many sub-systems is the gas delivery system, which is critical to IC pattern development and must deliver clean and controlled gases in a reliable and maintainable manner. While the gas delivery system takes up only ten to twenty percent of a process tool's volume, any reduction in its size is beneficial since it helps offset the necessary expansion of other components, such as the process chamber, which must be made larger to accommodate a 300 mm wafer. Gas delivery systems based on gas sticks constructed in the form of channeled stainless steel blocks are known in the art to accomplish such reduction.

The fluid distribution system of embodiments of the invention is designed to provide a manifold system for enabling the distribution of fluids, such as semi-conductor processing gases, and to provide an improved surface mount gas delivery system that will enable a standardization of the interface of active components. With standardized component interfaces, the production, distribution, and factory and field inventories of gas delivery components may be minimized and it will be possible to have an economy of scale while still permitting a subjective design to meet the demands of the customer.

Embodiments of the invention provide a solution to the issues of the prior art by providing a plurality of individual component bases with each component base having at least two fluid passageways. The surface may mount standard active components, such as mass flow controllers, pressure and flow measurement sensors, pressure regulators, gas dryers, filters, purifiers, valves, or any other customized component that is designed to operate with a known component, such as a valve. Unlike prior component bases, the active components rest on a surface that is provided on a single component base. Thus, the components are mounted directly on the component base without having to bridge or extend across adjacent component bases, except in the case of mass flow controllers or similar components. The component bases may be identical or similar in construction to ensure uniformity and precise production control of mounting surfaces.

By providing a modular and scalable composite manifold system, standardized individual component bases may be used with a standardized foot print for connection to the active components at each of the respective stations of the gas panel line. Thus, the composite component bases are arranged so that they receive gas, fluid or vapor at an inlet and may pass the fluid along to a plurality of internal channels that are sealed and connected to a plurality of active device receiving stations with the fluid ultimately being delivered to the semi-conductor manufacturing equipment. In the case of the valves shown throughout the drawings, the fluid delivery system is completed upon installing all of the components on the component bases.

The modular manifold system may be extended linearly in a direction by adding component bases and will position the body of each of the active components at substantially right angles to the face of the individual component bases that will be aligned along a common plane. The active components may be easily removed for repair or replacement. The manifold system may be self-aligning with each of the component bases being a repeatably machined component, which has been pre-fabricated. There is no necessity to provide welding connections or VCR tube connections since the active devices may be directly supported on and connected to the individual component bases with appropriate seals.

In certain embodiments, IC chip producers have improved the efficiency of their products by processing more semi-conductors on wafers of the larger diameter, such as 300 mm size wafers. Such design goals have placed further demands on process tool makers to minimize any increase in the size and footprint of equipment since workspace for the process tools is at a premium. There is also a desire to reduce the size of sub-systems and to increase their reliability to effectively reduce down time.

The component bases may be easily assembled with components and manifolds with seals that are compressed when securing the assembly. The seals are easily removable for replacement during repair.

The gas panel manifold system allows the gas panel to be easily reconfigured by a user in the field as welds and VCR connections need not be broken. An active device may be replaced or added by lifting it out of connection with an active device site and a new one connected thereto.

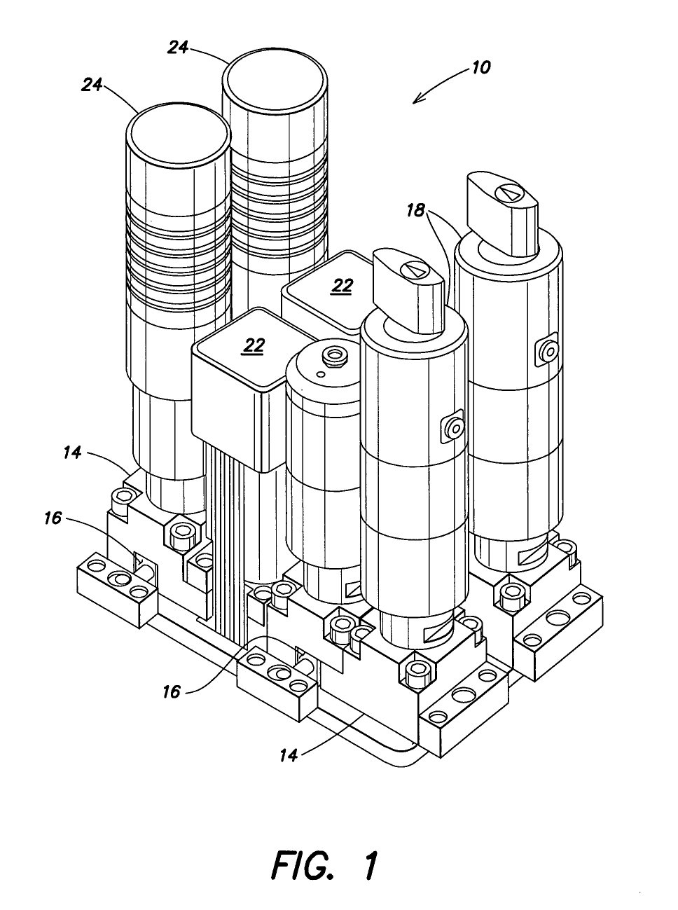

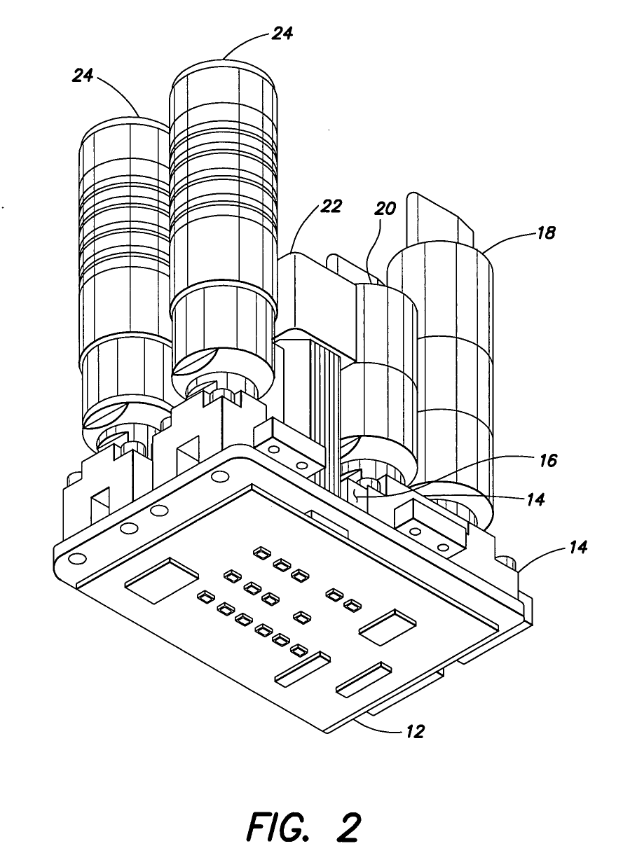

Referring to FIGS. 1 and 2, an embodiment of an exemplary fluid distribution system or module is disclosed and generally designated at 10. As will be discussed in greater detail below with reference to embodiments shown in FIGS. 10-14, the system 10 may be configured in any number of ways. As shown, the system 10 includes components that are mounted on an appropriate support surface, such as a backplane 12, by combining individual component bases, each generally designated at 14, to form an operative system. The component bases 14 are configured to interact with each other and with other components to distribute fluid in a first direction. Each component base 14 is generally identical in construction and may be formed from a stainless steel material, such as 316L stainless steel. Other suitable materials, e.g., polymers, may be used to fabricate the component base or any other component of the system that is fabricated from 316L stainless steel. Manifold fittings, each designated at 16, may be provided to distribute fluid in a second direction, which, as shown in FIGS. 1 and 2, is a direction generally perpendicular to the first direction.

As described above, the components may include manual valves, pneumatic valves, pressure regulators, pressure transducers, mass flow controllers, filters, purifiers and the like. All have the purpose of delivering precisely metered amounts of pure inert or reactant gas from the gas panel to the tool process chamber. As shown, the particular fluid distribution system 10 includes two hybrid valve actuators having positive shut-off mechanisms, each indicated at 18, two pneumatic valve actuators, each indicated at 20, two flow and pressure sensor modules, each indicated at 22, and two control/pneumatic valves, each indicated at 24. The component bases 14 are scalable so that additional components may be added to the system 10 depending on the desired configuration. The arrangement is such that the component bases 14 are configured to enable fluid communication between a hybrid valve 18, a purge valve 20, a flow and pressure sensor module 22 and a control/pneumatic valve 24 that are respectively mounted on a line of assembled component bases.

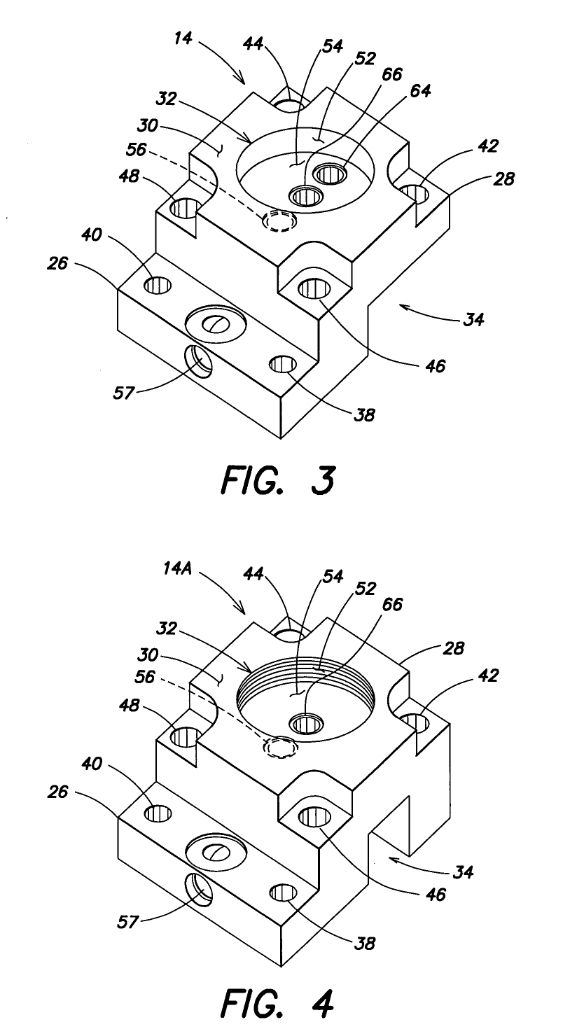

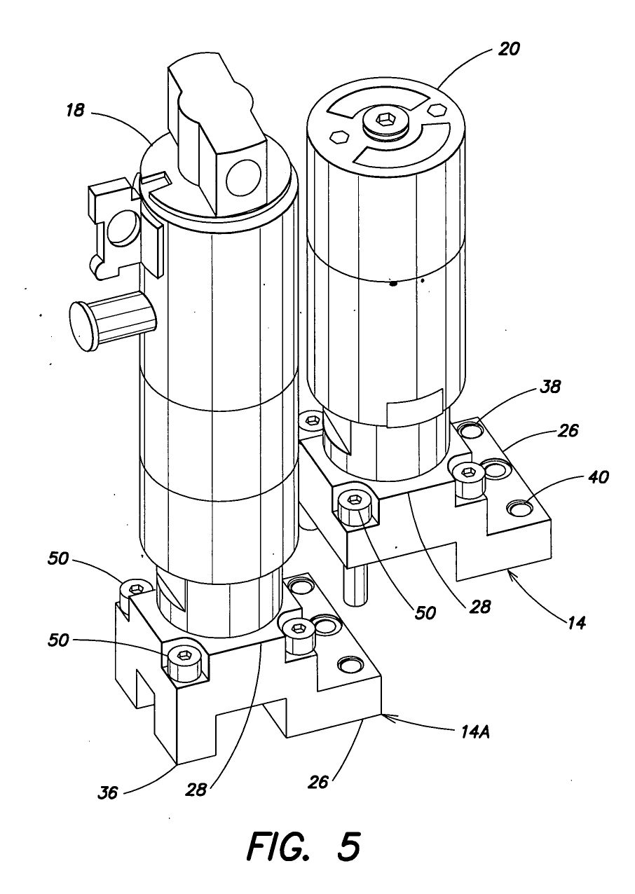

Turning now to FIG. 3, each component base 14 includes a lower flange segment 26 and an upper flange segment 28. The lower flange segment 26 is dimensioned to have a complimentary configuration to match the upper flange segment 28 of the immediately adjacent component base 14. The upper flange segment 28 includes a top surface 30 that is configured with a recess 32 to receive and secure the component, such as a valve or a flow meter, to the component base 14. As shown, the upper flange segment 28 is offset from the lower flange segment 26 by a gap 34. In some embodiments, this gap 34 beneath an active component may facilitate connection with a manifold fitting 16 to distribute fluid in the first direction. In yet another embodiment, this gap 34 beneath an active component may facilitate connection with a manifold fitting 16 to distribute fluid in the second direction. FIG. 3 illustrates a component base 14 having a three-port configuration with three gas passageways provided within the recess 32. FIG. 5 illustrates a two-port component base 14A having its lower flange segment configured with a portion 36 to engage the backplane 12.

As shown in FIGS. 3-5, the component base 14 is formed with two securement holes 38, 40 located at opposite ends of the lower flange segment 26. The securement holes 38, 40 may be used to secure the lower flange segment 26 of the component base 14 to the backplane 12. The securement holes 38, 40 may be through holes (non-threaded) or threaded, depending on the particular configuration. The upper flange segment 28 of the component base 14 includes four securement holes 42, 44, 46, 48 located at the four corners of the upper flange segment.

As shown, the arrangement is such that fasteners, each indicated at 50, such as Allen head bolts, may be inserted through the securement holes 42, 44 of an upper flange segment 28 of a component base 14 and through the securement holes 38, 40 of a lower flange segment 26 of an adjacent component base 14A to secure the component bases to the backplane 12. Two more fasteners 50 may be inserted into the remaining securement holes 46, 48 of the upper flange segment 28 of component base 14 to secure the component base 14 to the backplane 12. Additional fasteners 50 may be inserted into the securement holes 42, 44, 46, 48 of component base 14A to secure this component base to the backplane. As shown, for each securement hole 42, 44, 46, 48 formed in the upper flange 28, a portion of the upper flange is machined to receive the head of the Allen head bolt fasteners 50 therein. Thus, the heads of the Allen head bolt fasteners 50 may, for convenience of design, be recessed relative to the top surface 30 of the upper flange segment 28.

Prior to their installation to the backplane 12, the component bases 14, 14A shown in FIG. 5 may each be secured to a component. As shown, in a certain embodiment, component base 14A may support a hybrid valve actuator 18 having a manual shut-off control and component base 14 may support a pneumatic valve actuator 20. In other embodiments, these components may be secured to component bases 14, 14A after securing the component bases to the backplane 12. With reference to FIG. 3, in one embodiment, the components may be secured to the component bases by threadably coupling the parts together. Specifically, the recess 32 formed in the component base 14 may be formed with an annular wall 52 that is partially threaded so as to threadably engage a threaded surface provided on the component (not shown). The recess 32 is further formed with a bottom surface 54, which supports the bottom of the component once the component is threadably secured to the component base 14. Other methods and configurations may be employed to secure the component to the upper flange segment.

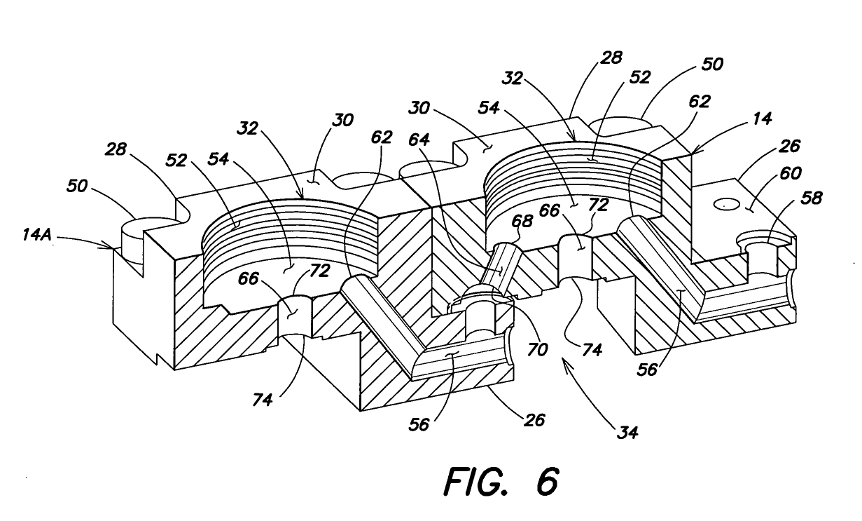

FIG. 6 further illustrates the flow of fluid through the interlocked component bases 14, 14A. As shown, component base 14 includes a fluid passageway 56 having an port 58 formed in a top surface 60 of the lower flange segment 26 that extends to another port 62 formed in the bottom surface 54 of the recess 32. In the embodiment shown in FIGS. 5 and 6, the component base 14 is a three-port component base and the component base 14A is a two-port component base. For component base 14, the fluid passageway 56 is configured to deliver fluid to the component. As shown in FIG. 4, a passageway 57 is formed in the lower flange segment 26 of the component base 14 to create a portion of passageway 56 leading to the port 62. After forming the passageway 56, the passageway 57 is closed (not shown) by any suitable method, such as welding the opening shut by means of a plug, for example. In the shown embodiment, the component may be a pneumatic valve actuator 20, which may be configured to deliver to or receive fluid from at least one of two fluid passageways 64, 66 formed in the bottom surface 54 of the recess 32. As shown, the first fluid passageway 64 includes a port 68 and another port 70, which may be in fluid communication with another component base, e.g. component base 14A, for example. Similarly, the second fluid passageway 66 includes a port 72 and another port 74, which may be in fluid communication with a manifold 16 to deliver to or receive fluid from a component of the system 10. In the shown embodiment, the ports 70, 74 of the first and second passageways 64, 66, respectively, are formed in a bottom surface of the top flange segment 28 that is co-planar with the top surface 60 of the lower flange segment 26. Thus, when securing a component to the component base 14, the component base places standardized ports on opposite facing surfaces, which sit in a common plane, thereby allowing adjacent components to connect without need to adjust relative height above the mounting surface.

As shown, the first fluid passageway 64 of component base 14 is in fluid communication with a fluid passageway 56 of component base 14A. The fluid passes between the fluid passageway 56 and the component secured to component base 14A, which may be, for example, a hybrid valve 18. In the shown embodiment, fluid flows between the fluid passageway 56 and the component and between the component and a fluid passageway 66 formed in the bottom surface 54 of the recess 32. The fluid passing through the fluid passageway 66 communicates with a manifold 16 and another component of the system, for example.

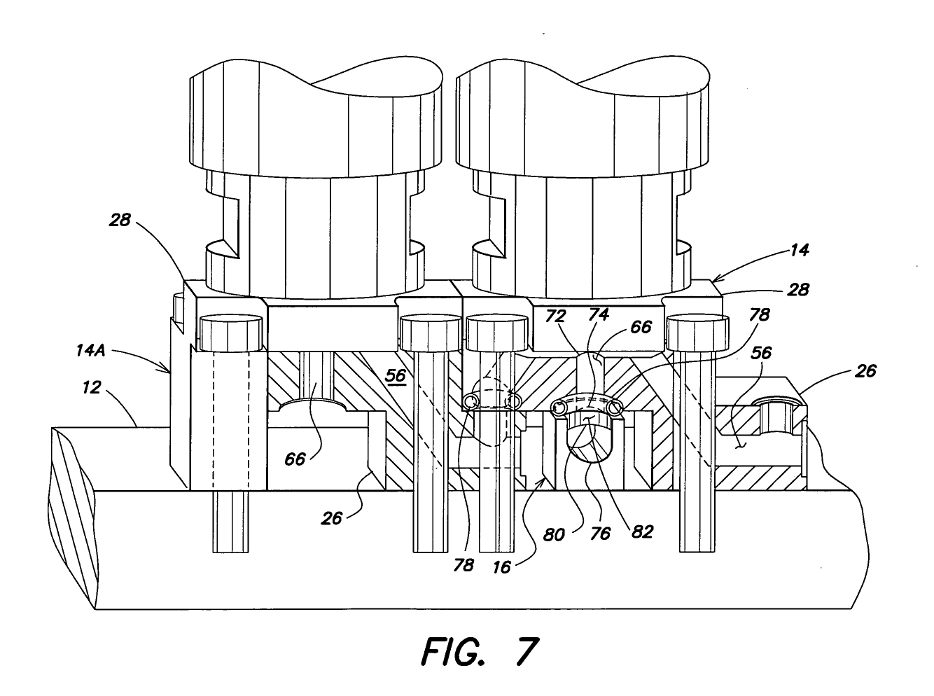

FIG. 7 illustrates the connection of component base 14 to a manifold 16 configured to deliver fluid from the component mounted on the component base 14 to another component of the system, for example. As shown, the manifold 16 includes a generally rectangular-shaped body having a fluid passageway 76 formed therein. A seal 78 is disposed between the port 74 of the fluid passageway 66 of component base 14 and a port 80 formed in the manifold 16. The port 80 is in fluid communication with a passageway 82 formed in the manifold 16. The arrangement is such that when mounting the component base 14 to the backplane 12, the seal 78 between the component base 14 and the manifold 16 is compressed to provide an airtight seal (to within industry standards) between them. In one embodiment, the seal may be fabricated from 316L stainless steel. Typical examples of such seals 78 may be purchased from Microflex Technologies of Huntington Beach, Calif. Exemplary seals may also be found in U.S. Pat. Nos. 6,357,760 and 6,688,608.

Specifically, to secure the component base 14, the securement holes 38, 40 of the lower flange segment 26 of the component base are aligned with the securement holes (not designated) of the backplane 12. The manifold 16 is positioned so that the port 80 of the manifold is in fluid communication with the port 74 of the second fluid passageway 66 of the component base 14, with the seal 78 positioned between the manifold and the component base. The seal 78 is compressed when securing the fasteners 50, including the fasteners provided in the securement holes 42, 44, 46, 48 of the upper flange segment 28 of the component base 14. Thus, compression of the seal takes place along the same axis as the direction in which the fasteners secure the component bases 14 to the backplane 12. The port 74 of the second fluid passageway 66 of the component base 14 and/or the port 80 of the manifold 16 may be configured to have recesses (not shown) formed around the ports to receive the seal 78 within the mating recesses.

This method of providing airtight communication (to within industry standards) between the component base 14 and the manifold 16 may be used to secure other components of the system 10. For example, to seal the passageway between the port 70 of the first fluid passageway 64 of the component base 14 and the port 58 of the fluid passageway 56 of component base 14A, a seal 78 may be disposed in between. This seal 78 is illustrated in FIG. 7. As shown, the seal 78 is compressed when securing the fasteners 50 in the manner described above. As with the seal disposed between the component base 14 and the manifold 16, the port 70 of the first fluid passageway 64 and/or the port 58 of the fluid passageway 56 of component base 14A may be configured to have recesses formed around the ports to receive the seal within the mating recesses.

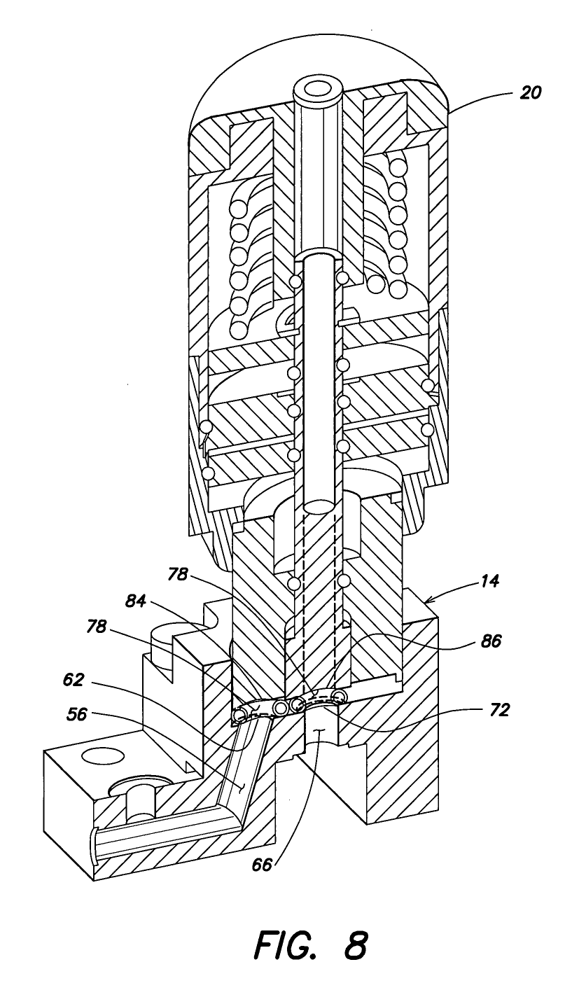

Referring to FIG. 8, a component, such valve actuator 18, may be secured to the component base 14 as follows. Specifically, the component 18 may be configured to include a port 84 to control fluid communication between the port 62 and the port 72 of the component base 14. The arrangement is such that when securing the component 18 to the component base 14 by threading the component to the component base, the port 84 of the component is aligned with the port 72 of passageway 66. The component 18 includes an actuator rod 85 that is connected at its end to an actuator head 86. A seat 87 is disposed within a recess (not designated) formed around the port 72. A diaphragm 88 is disposed between the seat 87 and the actuator head 86. The arrangement is such that when the actuator head 86 is moved toward the seat 87, the diaphragm 88 is captured therebetween to seal off the passage of any fluid between passageway 56 and passageway 66. To allow passage of fluid between the passageways 56, 66, the actuator rod 85 is raised thereby raising the actuator head 86 away from the seat 87. Fluid pressure within the passageways 56, 66 raises the diaphragm 88 away from the seat 87 to allow the passage of fluid therebetween.

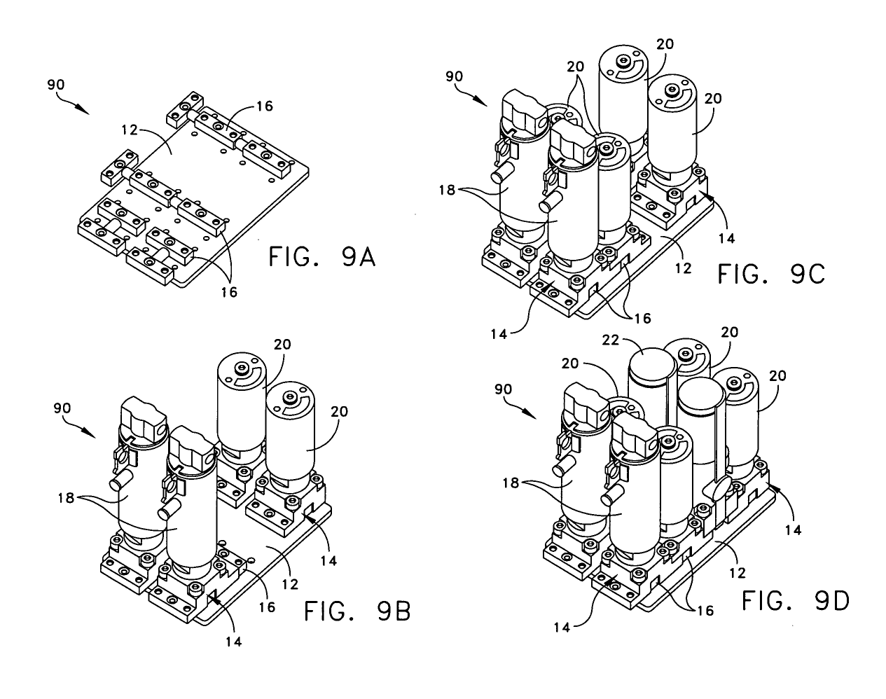

FIGS. 9A-9D illustrate the sequence of assembly of a fluid distribution module 90 of an embodiment of the invention. Specifically, in FIG. 9A, a backplane 12 is shown having manifolds 16 placed on the backplane. In FIG. 9B, component bases 14 may be mounted to the backplane 12 in a position in which the component bases extend over the manifolds 16 and are in fluid communication with the manifolds in the manner described above. Components may be secured to their respective component bases 14 either prior to or after the securing of the component bases to the backplane 12. As shown, the component bases 14A on the left-hand side of the module 90 may include hybrid valve actuators 18 and the component bases 14A on the right-hand side of the module may include pneumatic valve actuators 20.

FIG. 9C illustrates the attachment of two more pneumatic valve actuators 20 to the component bases 14, which are secured to the backplane 12. Specifically, the pneumatic valve actuators 20 are mounted on component bases 14, which are secured to the component bases 14A having the hybrid valve actuators 18. And finally, FIG. 9D shows a completed module 90 having components, e.g., flow and pressure sensor modules 22, spanning the component bases 14, 14A having the pneumatic valve actuators 20.

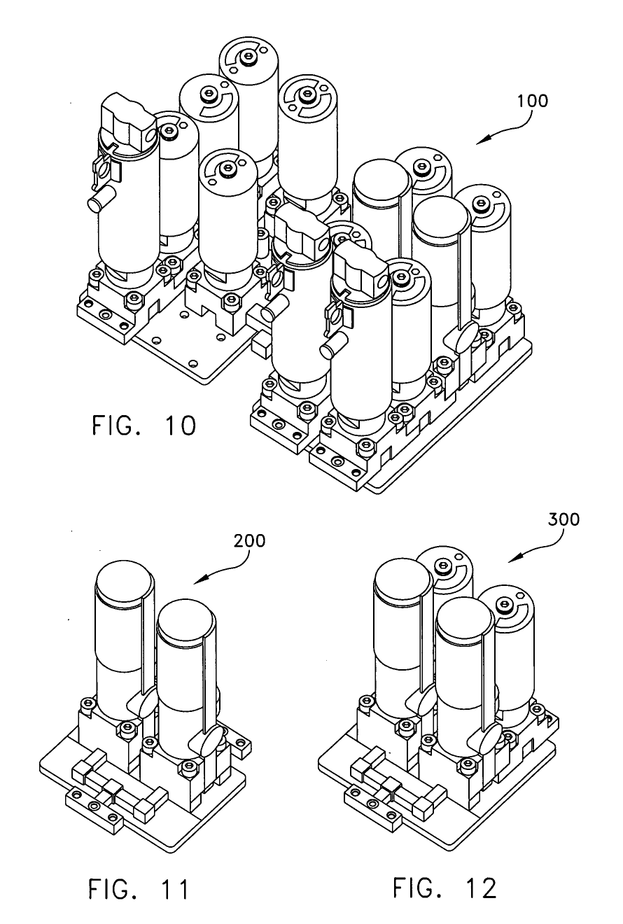

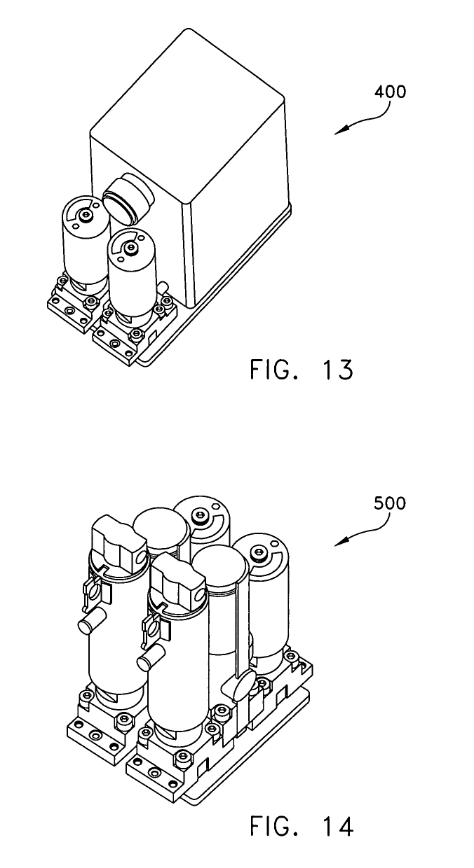

FIGS. 10, 11, 12, 13 and 14 illustrate exemplary modules 100, 200, 300, 400 and 500, respectively, incorporating principles of the invention. FIG. 10 illustrates a gas delivery module. FIG. 11 illustrates a ratio flow controller module. FIG. 12 illustrates a RFC module with a positive shutoff. FIG. 13 illustrates a mass flow verifier module, which utilizes rate of rise to verify mass flow control calibration in-situ. FIG. 14 illustrates a gas mixer module.

As mentioned, in certain embodiments, a 316L stainless steel may be used for the individual component bases and the internal passageways that are drilled in the stainless steel blocks have been passivated with chromium oxide to minimize specialty gas corrosion. The entrance and exit ports of each component are positioned to match the mating ports provided on adjacent component bases. This construction enables the internal connections of neighboring components to complete the flow path through the gas stick and eliminates the necessity of making space for tubing and fittings. The modular and scalable approach of component bases allow direct access to each component with mounting and removing of active components requiring only a manual hand tool, such as but not limited to an Allen wrench. By providing direct access to active components, it is possible to make repairs by replacing only the component base having the damaged component thereby reducing down time. Because the component bases are standardized, the design flexibility inherent in conventional welded systems is maintained since active components may be placed anywhere on the gas stick.

In certain embodiments, seals may be provided in the modular system and in the sealing processes described herein, which may comprise in certain embodiments a stainless steel seal or alternatively a malleable nickel seal, to produce a leak-free system (within industry standards).

In certain embodiments, the gas panel manifold system may further allow an entire manifold assembly, or stick, to have applied thereto heated tape or other types of heaters in order to heat all of the manifold bores extending among the active device components and maintain a low vapor pressure gas or vapor in a vapor state throughout each of the process gas lines of the system.

Thus, it should be observed that component bases of embodiments of the invention include a valve body, which satisfies the interconnection needs of the reduced complexity gas stick while eliminating much of the machining that is associated with a traditional surface mount substrate approach to this problem. The valve body uses a standardized bolted connection, which can accept either another valve, a complex flow control device, or a fluid path conduit interface as appropriate. The valve body minimizes the number of fluid path gasket seals required and uses only one plurality of fasteners to simultaneously effect the mechanical mounting and fluid interconnection of the devices. The valve body places standardized inlet and outlet ports on opposite facing surfaces, which sit in a common plane thereby allowing adjacent valves to connect without need to adjust relative height above the mounting surface and being interchangeable with connection to the complex flow control device.

In addition, the valve body efficiently uses fasteners because those fasteners, which attach the valve to the mounting surface, simultaneously impart the gasket compression necessary to effect the sealing among adjacent devices. In a three-port embodiment of the valve body, a transverse manifold gas path connection may additionally be effected while using only the same fasteners, which affix the valve body to the mounting surface. In contrast to other known configurations, component bases of embodiments of the invention avoid use of any additional parts when effecting connection between the transverse manifold and the lower connection port of the new valve body. The act of attaching the new valve body to the mounting plate also sealingly connects the transverse manifold. In contrast to other known configurations, the valve body has inlet and outlet ports oriented so the motion of securely attaching the valve body to a supporting structure is identical to the motion necessary to sealingly compress the fluid path gaskets. The valve body may have fluid flow in either direction. It should be understood to those skilled in the art that the identification of an inlet and an outlet are for convenience. By reversing the valve body orientation, it is possible for a single body design to be used when connecting to both ends of the complex flow control device.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the scope of the invention. Accordingly, the foregoing description and drawings are by way of example only.

What is claimed is:

1. A system for enabling a distribution of fluids comprising:
a backplane;
at least two component bases, each component base having a first flange segment on one side and a second flange segment on an opposite side, wherein each of the first flange segment and the second flange segment have through holes formed therein; and
at least one fastener to secure the at least two component bases to the backplane, the at least one fastener extending through the through holes formed in the first flange segment of a first component base and through holes formed in the second flange segment of a second component base and into the backplane.

2. The system of claim 1, wherein each of the first flange segment and the second flange segment have complimentary configurations that permit the at least two component bases to be interlocked, and wherein a first flange segment from one component base overlays a second flange segment of another component base.

3. The system of claim 1, wherein each component base has a first fluid passageway and a second fluid passageway.

4. The system of claim 3, wherein the first fluid passageway includes a first port formed in the second flange segment of the component base and a second port formed in the first flange segment of the component base.

5. The system of claim 4, wherein the second fluid passageway includes a first port formed on an upper surface of the first flange segment and a second port formed on a lower surface of the first flange segment.

6. The system of claim 5, wherein the first port of the first fluid passageway is co-planar with the second port of the second fluid passageway.

7. The system of claim 5, further comprising a manifold in fluid communication with at least one of the first fluid passageway and the second fluid passageway of one of the at least two component bases.

8. The system of claim 7, further comprising a seal disposed between one of the at least two component bases and the manifold.

9. The system of claim 8, wherein the seal is a compressible seal that is compressed when securing the component bases to the backplane with the at least one fastener.

10. The system of claim 8, wherein the at least two component bases extend in a first direction, and wherein the manifold extends in a second direction.

11. The system of claim 10, wherein the second direction is generally perpendicular to the first direction.

12. The system of claim 3, further comprising a component mounted on one of the at least two component bases, the component being in fluid communication with at least one of the first fluid passageway and the second fluid passageway.

13. A system for enabling a distribution of fluids comprising:
a backplane;
at least two component bases secured to the backplane, each component base being configured to be secured in interlocking relationship with an adjacent component base and having a fluid passageway with a first port and a second port;
a manifold in fluid communication with at least one of the first port and the second port of the fluid passageway of one of the at least two component bases; and
a seal disposed between the manifold and the at least one of the first port and the second port of the fluid passageway of the at least one of the component bases, the seal being compressed when securing the at least two component bases to the backplane.

14. The system of claim 13, wherein each component base further has a first flange segment on one side and a second flange segment on an opposite side, and wherein each of the first flange segment and the second flange segment have through holes formed therein.

15. The system of claim 14, wherein each of the first flange segment and the second flange segment have complimentary configurations that permit the at least two component bases to be interlocked, and wherein a first flange segment from one component base overlays a second flange segment of another component base.

16. The system of claim 15, wherein the seal is a compressible seal that is compressed when securing the at least two component bases to the backplane.

17. A manifold system for enabling a distribution of fluids comprising:
a backplane;
at least two component bases, each component base having a fluid passageway with a port;
a manifold in fluid communication with the port of one of the at least two component bases;
a seal disposed between the port of one of the at least two component bases and the manifold; and
at least one fastener to secure the one of the at least two component bases to the backplane, and
wherein the seal is compressed when securing the one of the at least two component bases to the backplane with the at least one fastener.

18. The manifold system of claim 17, wherein each component base further has a first flange segment on one side and a second flange segment on an opposite side, and wherein each of the first flange segment and the second flange segment have through holes formed therein.

19. The manifold system of claim 18, wherein each of the first flange segment and the second flange segment have complimentary configurations that permit the at least two component bases to be interlocked, and wherein a first flange segment from one component base overlays a second flange segment of another component base.

20. The manifold system of claim 17, wherein the plurality of individual component bases extends in a first direction, and wherein the manifold extends in a second direction.

21. The manifold system of claim 20, wherein the second direction is generally perpendicular to the first direction.

22. A method of assembling a fluid distribution system, the method comprising:
providing a backplane;
providing two component bases, each component base having a first flange segment on one side and a second flange segment on an opposite side, wherein each of the first flange segment and the second flange segment have through holes formed therein;
positioning a first component base on the backplane;
positioning a second component base on the backplane in a position in which the first flange segment of the second component base overlies the second flange segment of the first component base; and
securing the first and second component bases to the backplane with a fastener that extends through the through holes of the first flange segment of the second component base and the second flange segment of the first component base.

23. The method of claim 22, further comprising compressing a seal disposed between a manifold disposed under the first flange segment of the first component base.

24. A method of assembling a fluid distribution system, the method comprising:
providing a backplane;
securing at least two component bases to the backplane, each component base having at least one fluid passageway formed therein;
positioning a manifold in fluid communication with at least one fluid passageway of one of the at least two component bases;
positioning a seal between the manifold and the at least one fluid passageway of one of the at least two component bases; and
compressing the seal when securing the one of the at least two component bases to the backplane.
